(19) United States
(12) Patent Application Publication
(10) Pub. No.: US 2011/0237239 A1
(43) Pub. Date: Sep. 29, 2011

(54) METHOD AND APPARATUS FOR SELECTIVELY MUTING A CONTROL CHANNEL FOR A FEMTOCELL FOR INTERFERENCE AVOIDANCE

(75) Inventors: Chie-Ming Chou, Qingshui Town (TW); Jung-Mao Lin, Dali City (TW)

(73) Assignee: Industrial Technology Research Institiute

(21) Appl. No.: 12/909,520

(22) Filed: Oct. 21, 2010

Related U.S. Application Data
(60) Provisional application No. 61/317,569, filed on Mar. 25, 2010.

(51) Int. Cl. H04W 4/00

(52) U.S. Cl. 455/422.1

(57) ABSTRACT

A method of providing a framework for efficient scanning and session establishment may include receiving vocabulary independent property information indicative of a property request and corresponding setting information of an application associated with a device capable of communication with a network communication environment, determining capabilities of the network communication environment relative to the received property information, and enabling generation of a selected scan function having selected scan parameters based at least in part on the determined capabilities and the property information. A corresponding apparatus and computer program product are also provided.

### CROSS REFERENCE TO RELATED APPLICATION

This application claims the benefit of U.S. Provisional Application No. 61/317,569, filed Mar. 25, 2010, the contents of which are incorporated herein in their entirety.

### TECHNOLOGICAL FIELD

Embodiments of the present invention relate generally to wireless communication technology and, more particularly, relate to a method and apparatus for providing interference avoidance in a network including a femtocell, for example, by selectively muting a control channel for the femtocell.

### BACKGROUND

There is a growing interest among operators to deploy broadband access networks including one or more small scale base stations known as Femto base stations or home nodeBs. More recently, more advanced versions of these devices, known sometimes as ABS (advanced base stations) or home eNodeBs have been proposed for use in order to improve the service coverage and provide a better broadband experience for users attempting to access wireless networks in their houses and small offices. Hereinafter, we will refer generally to such devices as “Femto ABS” to represent a broadband access base station that may employ example embodiments of the present invention. A Femto ABS may be a low-power wireless base station that may operate in the licensed or unlicensed spectrum to connect standard mobile devices to a mobile operator's network using residential DSL or cable broadband connections. As such, a wireless connection may be provided to communication devices within range of the Femto ABS, but the Femto ABS may be connected to the wireless network itself using a wired backhaul interface. The Femto ABS may therefore provide wireless coverage to an area that overlaps to some degree with resources of the wireless network (e.g., the coverage area of a Macro ABS). The spectrum employed by the Femto ABS may be the same as or different than the spectrum that is employed by the Macro ABS.

A Femto ABS may be inserted into the wireless network as a plug-and-play product. When initializing, the Femto ABS may be configured to measure its environment and make configurations by itself to optimize the network. The configurations made may include frequency assignment, interference control, and other activities. When providing services to users, there are generally two classifications of Femto ABSs including closed-access Femto ABSs and open-access Femto ABSs. A closed-access Femto ABS may only allow a registered and authorized AMS (advanced mobile station) that is in the white list of the Femto ABS to access the network. Meanwhile, an open-access Femto ABS may allow an AMS to access without being required to be on the white list.

To obtain relatively high spectrum efficiency, a Femto ABS using the same spectrum as a Macro ABS (e.g., co-channel operation) may be employed. Unfortunately, co-channel situations may introduce interference that can even be large in some cases. FIG. 1 illustrates two scenarios in which poor performance may result while employing a co-channel. As such, FIG. 1 illustrates two example situations that may commonly be encountered in typical communication environments in which example embodiments may be employed. As shown in FIG. 1, a Macro ABS 10 may provide a coverage area 12 that extends over a relatively wide area. Two Femto ABSs (e.g., Femto ABS 1 and Femto ABS 2) may be located within the coverage area 12 of the Macro ABS 10, and each may define its own respective smaller coverage area (e.g., coverage areas 21 and 22, respectively). Two AMSs may also be within the example network of FIG. 1 including a Macro AMS 30 and a closed service group (CSG) AMS 32.

When the location of a Femto ABS is close to the location of the Macro ABS 10 (e.g., as is the case for Femto ABS 1), the downlink power of the Macro ABS 10 may interfere with the downlink power of the Femto ABS. Thus, for example, the CSG AMS 32, which is served by the Femto ABS 1, may receive signals with a relatively strong downlink power from the Macro ABS 10 and the received signals may interfere with the downlink signals transmitted by the Femto ABS 1 that is serving the CSG AMS 32.

Another potential interference scenario may be created when an inaccessible AMS (e.g., the Macro AMS 30, which is not allowed to be served by the Femto ABS 2 since it is not a member of the CSG of the Femto ABS 2) enters into the coverage area of a Femto ABS that is relatively far away from the Macro ABS 10 (as is the case for Femto ABS 2 in FIG. 1). Because the Macro AMS may be within the coverage area 22 of the Femto ABS 2, but is not allowed to access the network via the Femto ABS 2, the downlink power of the Femto ABS 2 may interfere with the downlink power of the Macro ABS 10 and transmissions by the Macro ABS 10 may fail to be discernable at the Macro AMS 30. This scenario may occur dynamically and may be dependent upon the location of an AMS served being within an area of overlapping coverage of the Macro ABS 10 and a Femto ABS with which the AMS is not associated or cannot associate.

FIG. 2 shows a conventional frame structure to further explain typical operation in conventional equipment. The conventional frame structure includes an SA-Preamble 50, a super frame header (SFH) 52, followed by a downlink (DL) frame 54 and an uplink (UL) frame 56. In a conventional situation, an AMS may typically attempt to find the synchronization signal or channel (e.g., similar to the SA-Preamble 50 in FIG. 2) for downlink synchronization when it powers on. After completing the synchronization, the AMS may be enabled to receive system information (including, for example, the primary SFH (P-SFH) and secondary SFH (S-SFH)), which may be carried in the control channel. The control channel is typically allocated at a predetermined frame structure as shown in FIG. 2. After successful decoding of the system information, the AMS may know the parameters for the corresponding ABS and further proceed to network entry (e.g., by uplink synchronization through a ranging channel, authorization and registration, capability negotiation, etc.). If interference occurs, the interference may be avoided by resource reservation, by partition or by other interference mitigation schemes. However, the allocation of the control channel should typically be fixed and thus, those schemes may not be able to be applied. Since the control channel carries the system information and an AMS couldn't operate without the system information, it may be desirable to develop an improved interference mitigation scheme on the control channel.

### BRIEF SUMMARY

A method and apparatus are therefore provided for enabling the provision of a method of interference avoidance. For example, some embodiments may provide for selectively muting a control channel for the Femtocell to provide interference avoidance. Accordingly, for example, an alternative procedure and structure may be provided to enable users to access a Femtocell without decoding the control channels. Coverage holes caused by interference between Macrocell base stations and Femtocell base station may then be removed or further mitigated to improve overall system capacity by enabling users to avoid interference with respect to acquisition of system information.

In one exemplary embodiment, a method of providing interference avoidance in a Femtocell network is provided. The method may include receiving, at a Femtocell, a mobile station generated-message relating to provision of system information of the Femtocell to the mobile station, and selectively providing the system information of the Femtocell to the mobile station based on the mobile station-generated message.

In another exemplary embodiment, an apparatus for providing interference avoidance in a Femtocell network is provided. The apparatus may include processing circuitry configuring the apparatus to receive, at a Femtocell, a mobile station generated-message relating to provision of system information of the Femtocell to the mobile station, and selectively provide the system information of the Femtocell to the mobile station based on the mobile station-generated message.

In another exemplary embodiment, an alternative method for providing interference avoidance in a Femtocell network is provided. The method may include generating, at a mobile station, a message relating to provision of system information of a Femtocell to the mobile station, and providing the message to a network entity to initiate selective provision of the system information of the Femtocell to the mobile station based on the message.

In another exemplary embodiment, a system for providing interference avoidance in a Femtocell network is provided. The system may include a Femto base station having a coverage area overlapping with at least one neighbor cell, and a mobile station capable of receiving signaling from the Femto base station. The mobile station may be configured to generate a message relating to provision of system information of the Femto base station to the mobile station, and provide the message to the Femto base station or the neighbor cell. The Femto base station may be configured to selectively provide the system information of the Femto base station to the mobile station based on the message.

Some embodiments of the invention may therefore provide a methods, apparatus and system that may provide device users with improved capabilities and user experience with respect to accessing wireless networks via mobile devices.

### BRIEF DESCRIPTION OF THE SEVERAL VIEWS OF THE DRAWING(S)

The foregoing summary, as well as the following detailed description of the invention, will be better understood when read in conjunction with the appended drawings. For the purpose of illustrating embodiments of the invention, there are shown in the drawings embodiments which are examples. It should be understood, however, that the invention is not limited to the precise arrangements and instrumentalities shown. In the drawings:

FIG. 1 illustrates two scenarios in which co-channel operation may be provided according to an example embodiment;

FIG. 2 shows a conventional frame structure to further explain typical operation in conventional equipment;

FIG. 3 illustrates a control flow diagram for the provision of system information to a mobile station via a macro base station according to an example embodiment;

FIG. 4 illustrates a frame structure for supporting detection of the presence of an always-muting Femto base station according to an example embodiment;

FIG. 5, which includes FIGS. 5A, 5B and 5C, shows examples of mechanisms by which updated system information may be provided to an on-serving mobile station according to an example embodiment;

FIG. 6, which includes FIGS. 6A, 6B and 6C, illustrates message sequences associated with operation of example embodiments involving a mobile station to be paged;

FIG. 7, which includes FIGS. 7A and 7B, illustrates an example of a Femto base station support for updating system information for an idle mode mobile station with Femto base station support for a different paging group identifiers (PGIDs) or for the same PGID according to an example embodiment;

FIG. 8 illustrates an example in which a mobile station may send an interference mitigation request to inform the Femto base station that the mobile station is experiencing interference according to an example embodiment;

FIG. 9 is a block diagram according of an apparatus for providing interference avoidance in a Femtocell network according to an example embodiment;

FIG. 10 is a block diagram according to a method for providing interference avoidance in a Femtocell network according to an example embodiment; and

FIG. 11 is a block diagram according to another method for providing interference avoidance in a Femtocell network according to an exemplary embodiment.

### DETAILED DESCRIPTION

Reference will now be made in detail to the present embodiments of the invention, examples of which are illustrated in the accompanying drawings. Wherever possible, the same reference numbers will be used throughout the drawings to refer to the same or like parts. As used herein, the terms “data,” “content,” “information” and similar terms may be used interchangeably to refer to data capable of being transmitted, received and/or stored in accordance with embodiments of the present invention. Moreover, the term “exemplary,” as used herein, is not provided to convey any qualitative assessment, but instead merely to convey an illustration of an example. Thus, use of any such terms should not be taken to limit the spirit and scope of embodiments of the present invention.

As indicated above, control channel interference may be encountered when an AMS attempts to obtain system information while within the coverage area of both a Femtocell and a Macrocell. To overcome this interference in the control channel (e.g., the SFH in an IEEE802.16 system or the physical broadcast channel (PBCH) in a long term evolution (LTE) system), an example embodiment may employ selective muting within the Femtocell. For example, the Femto ABS may be enabled to mute its SFH (representative of a control channel herein). Accordingly, the Femto ABS may selectively provide its system information through the control channel to prevent interference. In some cases, the system information may be provided to an AMS dependent upon the state of the AMS. The state of the AMS may be one of the following including an idle mode AMS, a new or incoming AMS, an AMS that is to be paged, or an AMS being served. Different operations regarding system information transmission may be applied for each of the different states outlined above. Moreover, the selective muting described above may include an embodiment for always muting the SFH and/or an embodiment for event-based muting of the SFH.

For the always-muting case mentioned above, the Femto ABS may be biased to mute the SFH and may un-mute in response to certain stimuli. For example, the Femto ABS may be configured to normally mute the SFH and stop muting the SFH in response to receipt of a request from an AMS. Once the Femto ABS stops muting the SFH, a timer may be initiated. In response to the Femto ABS receiving a response from the AMS to indicate that the receipt of system information is complete, the Femto ABS may resume muting of the SFH. Otherwise, if no response indicating completion of receipt of the system information is received, the Femto ABS may resume muting when the timer expires.

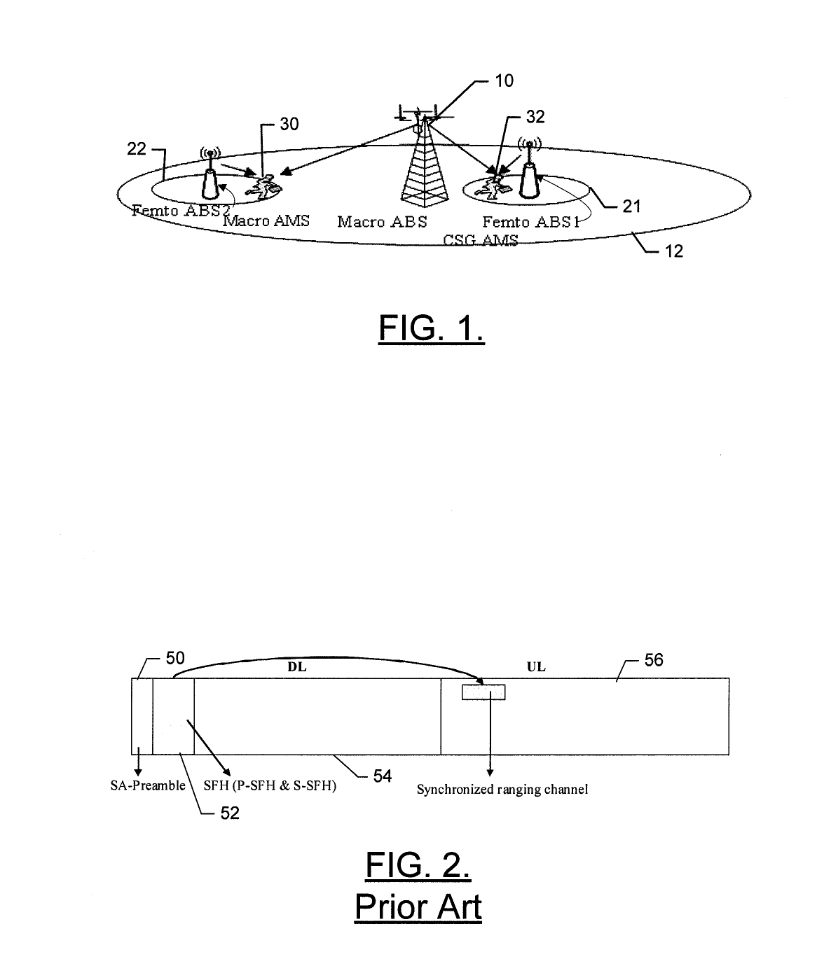

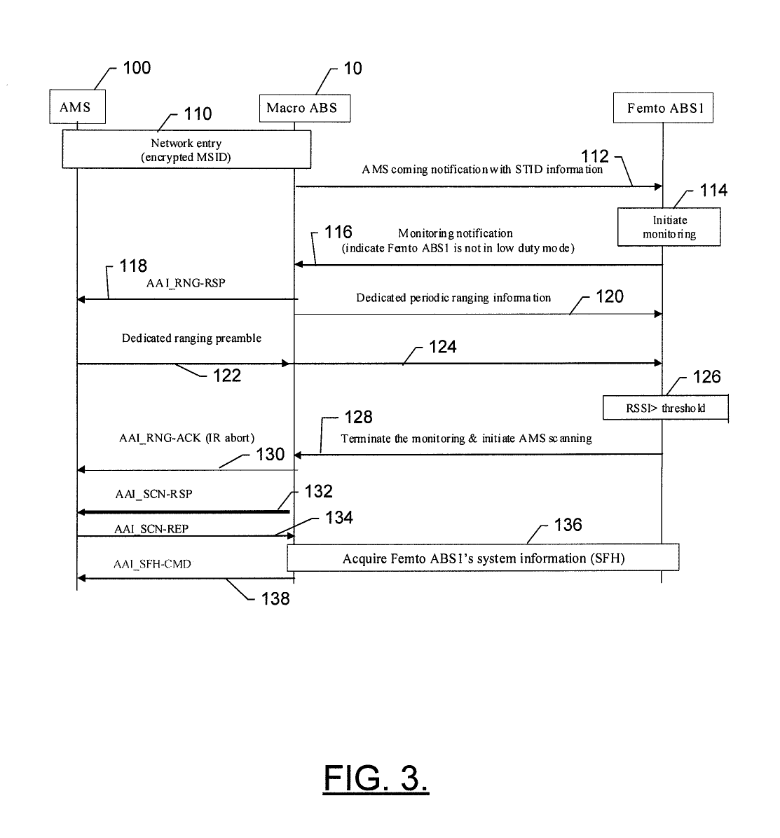

For the always-muting case, when a new AMS (e.g., the term “new” referring only to the fact that the AMS was not in the coverage area of the corresponding Femto ABS in preceding moments and not referring to either the age of the AMS or whether the AMS was in the Femto ABS coverage area at some more distant prior time) enters the coverage area of the Femto ABS, the new AMS may receive system information via the overlapped Macro ABS (e.g., Macro ABS 10 of FIG. 1). FIG. 3 illustrates a control flow diagram for the provision of system information to an AMS via a Macro ABS according to an example embodiment. As shown in FIG. 3, an AMS 100 may power on within the coverage area of the Macro ABS 10 and the Femto ABS 1. The AMS 100 may detect the preamble of the Femto ABS 1, but may not be able to find the SFH of the Femto ABS 1 (since the Femto ABS 1 may be muting its SFH). The AMS 100 may then be configured to select the Macro ABS 10 as its serving cell even though the AMS 100 is still in the coverage area of the Femto ABS 1. When the AMS 100 is served by the Macro ABS 10, a proximity mechanism may thereafter indicate that the AMS 100 could be served by the Femto ABS 1 and handover procedures may be initiated. During handover preparation, the overlapped Macro ABS 10 may transmit the system information of the Femto ABS to the AMS 100 by sending a unicast message (e.g., an advanced air interface superframe header command (AAI_SFH-CMD) message as shown in FIG. 3). The Macro ABS 10 may be configured to acquire the system information of the Femto ABS 1 through the backhaul in order to support the provision of the system information of the Femto ABS 1 to the AMS 100 without the Femto ABS 1 potentially sending interfering messages to the AMS 100, but instead muting the SFH of the Femto ABS 1. The Macro ABS 10 may be configured to store the system information and then directly reply to the AMS 100 when proximity conditions are met. The Femto ABS 1 may send a notification to the Macro ABS 10 if the system information updates.

As shown in FIG. 3, when the AMS 100 powers on, the AMS 100 may initially perform network entry via the Macro ABS 10 at operation 110. The Macro ABS 10 may inform the Femto ABS 1 that the AMS 100 provided a notification with its STID information at operation 112. The Femto ABS 1 may initiate monitoring accordingly at operation 114. The Femto ABS 1 may send a monitoring notification to the Macro ABS 10 at operation 116. The Macro ABS 10 may then send an AAI_RNG-RSP message to the AMS 100 at operation 118 and send dedicate periodic ranging information to the Femto ABS 1 at operation 120. The AMS 100 may communicate a dedicated ranging preamble to the Macro ABS 10 at operation 122, which may be relayed on to the Femto ABS 1 at operation 124. The Femto ABS 1 may determine whether the received signal strength indication (RSSI) is greater than a particular threshold at operation 126 and send a message to the Macro ABS 10 at operation 128 to terminate monitoring and initiate AMS scanning. The Macro ABS 10 may send an AAI_RNG-ACK message to the AMS 100 at operation 130 and send an AAI_SCN-RSP message at operation 132. The AMS 100 may communicate an AAI_SCN-REP at operation 134 after which the Macro ABS 10 may acquire the system information (e.g., SFH) of the Femto ABS 1 at operation 136. The system information of the Femto ABS 1 may then be provided to the AMS 100 at operation 138 via the AAI_SFH-CMD message.

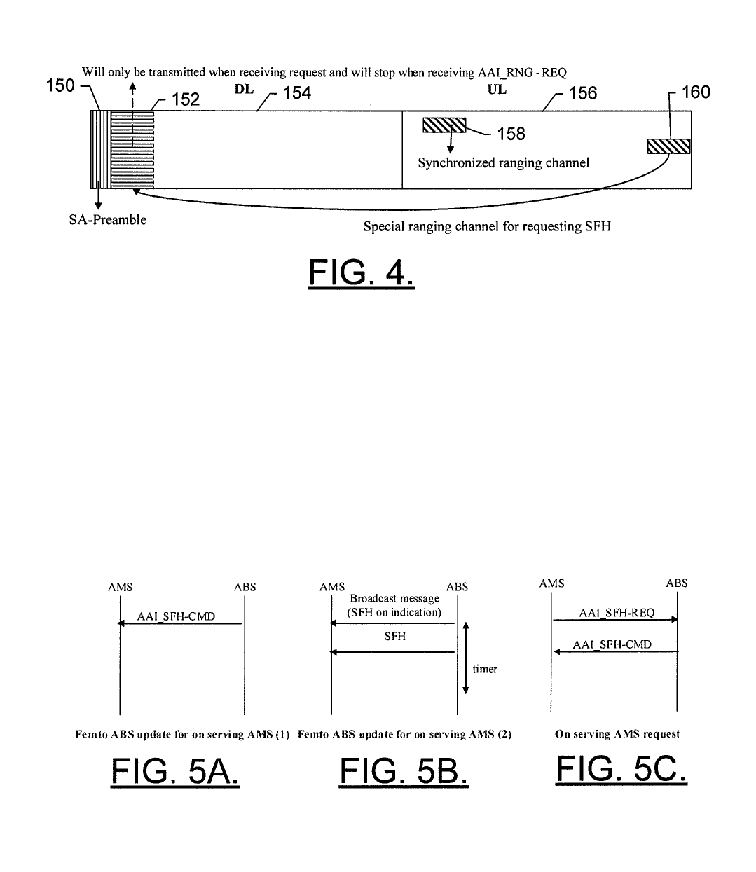

As another approach, the powered up AMS 100 may request the system information of the Femto ABS in response to detecting the presence of an always-muting Femto ABS. The presence of an always-muting Femto ABS may be indicated, for example, by the receipt of a strong preamble from a Femto ABS without any SFH at the AMS 100. FIG. 4 illustrates a frame structure for supporting detection of the presence of an always-muting Femto ABS as described above. The SA-preamble 150 of FIG. 4 will always be transmitted, but the SFH 152 may not be transmitted except when a request for the system information is received (e.g., via an AAI_RNG-REQ message). The DL frame 154 and the UL frame 156 may then be provided in order with synchronized ranging information 158 being provided in a portion of the UL frame 156. The UL frame 156 may also include a special ranging channel 160 for enabling the AMS to request the SFH.

In cases in which it is desirable for the Femto ABS to update its system information while the Femto ABS is serving an AMS, the Femto ABS may be configured to notify the AMS by transmitting a unicast message (e.g., the AAI_SFH-CMD message). FIG. 5, which includes FIGS. 5A, 5B and 5C, shows examples of mechanisms by which the updated system information (e.g., SFH update) may be provided to an on-serving AMS (e.g., an AMS already being served by a Femto ABS). FIG. 5A illustrates an example in which the serving Femto ABS simply sends the unicast message (e.g., the AAI_SFH-CMD message) to the AMS to inform the AMS of the changed system information. FIG. 5B illustrates an example in which the AMS is in a sleep mode and there is a timing window defining an available interval during which scheduling information may be communicated. The Femto ABS may communicate a broadcast message initially and then send the SFH within the available interval defined. FIG. 5C illustrates another example in which the on-serving AMS requests system information. The request may come for any reason such as, for example, the AMS losing some portion of the information. As shown in FIG. 5C, the AMS may send a request for the system information (e.g., via an AAI_SFH-REQ) and the Femto ABS may respond with the system information (e.g., via an AAI_SFH-CMD). In some cases, the AMS may append a change count of its stored information into the request message to help the Femto ABS to verify the system information version that is requested.

For an AMS that is to be paged by an always-muting Femto ABS (e.g., an on-paging AMS) when the Femto ABS attempts to update its system information, the Femto ABS may notify the on-paging AMS by providing a paging message to recommend that the on-paging AMS wake up. After AMS wake-up, the Femto ABS may transmit a unicast message to the AMS to provide the updated system information. In some cases, the on-paging AMS may request updated (or a retransmission) of the system information by either performing a network re-entry and then sending a message as if the AMS had previous system information regarding this Femto ABS or performing a request mechanism as addressed above for a new AMS. For network re-entry, the Femto ABS may precede the update process in the same manner described above for an on-serving AMS. For performing an update request, instead of updating the system information, an on-paging AMS may change the paged cell from a Femto ABS to a Macro ABS if the AMS does not desire to process the update.

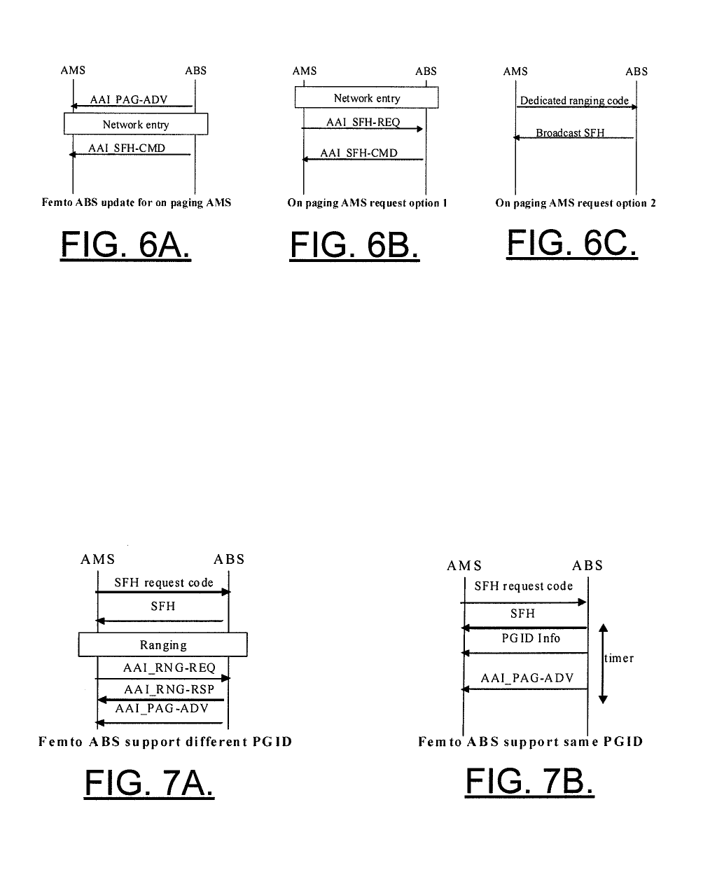

FIG. 6, which includes FIGS. 6A, 6B and 6C, illustrates examples of operation of example embodiments involving an AMS to be paged. FIG. 6A illustrates a Femto ABS providing an AAI_PAG-ADV message in response to which a network entry is performed followed by the provision of system information to the AMS via the AAI_SFH-CMD message.

FIG. 6B illustrates a network entry being performed after which the AMS issues a request for system information via a AAI_SFH-REQ message in response to which the system information is provided to the AMS via the AAI_SFH-CMD message. In FIG. 6C, a dedicated ranging code is provided to the Femto ABS and the Femto ABS responds with a broadcast SFH to provide the AMS with the system information.

For an idle mode AMS in the coverage area of a Femto ABS that practices always-muting the SFH, multiple options may be available to the idle mode AMS, examples of which are shown in FIG. 7. FIG. 7, which includes FIGS. 7A and 7B, illustrates an example of Femto ABS support for updating SFH for an idle mode AMS with Femto ABS support for a different PGID (FIG. 7A) or for the same PGID (FIG. 7B). For example, the AMS may be configured to listen for a paging message from the Macro ABS even if it finds a stronger SA-preamble but no SFH of a Femto ABS (indicating an always-muting Femto ABS). Alternatively, the AMS may be configured to perform a request as described above for a new oncoming AMS to obtain system information. If the Femto ABS supports different paging group identifiers (PGIDs), then the AMS may perform a location update and the ABS may re-start muting the SFH after network entry procedures are complete. If the Femto ABS supports the same PGID, the AMS may inform the Femto ABS that it may restart muting the SFH or the Femto ABS may restart muting the control channel upon timer expiry.

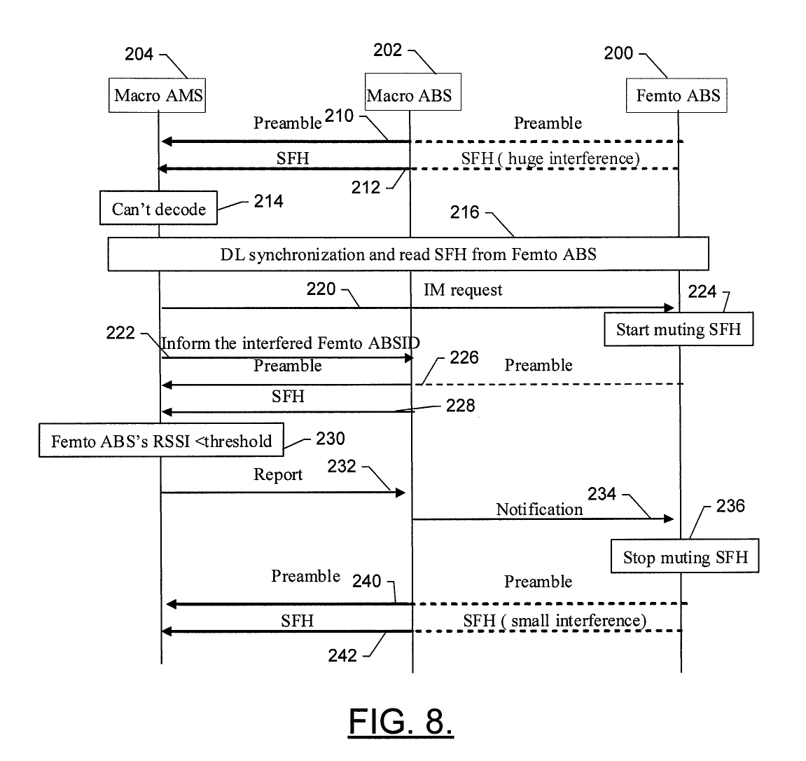

As indicated above, as an alternative to providing an always-muting SFH Femto ABS, event-based muting of the SFH for the Femto ABS may be accomplished. Event-based muting may involve muting of the SFH by the Femto ABS only when predefined criteria are met or stopping muting of the SFH by the Femto ABS only when predefined criteria are met. For example, in some cases event-based muting may be initiated when there are AMSs served by a Macro ABS and one or more of the AMSs report interference caused by the Femto ABS. In such an example, the Femto ABS may otherwise send system information until an AMS reports interference. FIG. 8 illustrates an example in which an AMS may send an interference mitigation (IM) request to inform the Femto ABS that the AMS is experiencing interference. Generally speaking, after receiving the IM request, the Femto ABS may stop providing the system information via its control channel (i.e., mute its SFH).

As shown in FIG. 8, a Femto ABS 200 and a Macro ABS 202 may initially be communicating preamble (as indicated at operation 210) and SFH (as indicated by operation 212) to an AMS 204 such that the SFH causes interference. The interference may prevent the AMS 204 from being able to decode the SFH at operation 214. DL synchronization may then occur and the Macro ABS 202 may read the SFH from the Femto ABS 200 at operation 216. The AMS 204 may then communicate an IM request 220 to the Femto ABS 200. In some cases, the AMS 204 may also indicate the ABS identifier (ABSID) of the Femto ABS 200 to the Macro ABS 202 at operation 222. In response to receipt of the IM request, the Femto ABS 200 may start muting as indicated at operation 224. Thereafter, only the preamble from the Femto ABS 200 may be provided along with the preamble from the Macro ABS 202 as indicated at operation 226. Only the Macro ABS 202 may send SFH thereafter as indicated at operation 228 due to muting of the SFH of the Femto ABS 200.

However, if the Femto ABS 200 ends up being a large enough distance away from the AMS 204 to reduce the interference below acceptable levels, the muting may be stopped. The criteria for determining the distance at which muting may be stopped can be varied in different embodiments. Thus, for example, in some cases the RSSI from the Femto ABS may be measured with respect to a threshold value by the AMS 204 (as indicated at operation 230) and the AMS 204 may report (as indicated at operation 232) to the Macro ABS 202 when the RSSI declines to below the threshold value. The Macro ABS 202 may then notify the Femto ABS 200 at operation 234 so the Femto ABS 200 may stop muting as indicated at operation 236. Thereafter, the Femto ABS 200 and the Macro ABS 202 may each communicate preamble (as indicated at operation 240) and SFH (as indicated by operation 242) to the AMS 204 such that the SFH causes only a small amount of interference to the AMS 204.

In an example embodiment, the decision on whether to begin muting may also be made based on distance. Thus, for example, either or both of initiating and stopping muting may be accomplished based on distance information that may be gathered via any of a plurality of different methods. In some cases, distance may be determined based on RSSI measurements as indicated above. However, in other instances, GPS distance or another mechanism by which to determine distance may be employed. As such, when the distance between the Femto ABS 200 and the AMS 204 decreases below a threshold distance, muting may be initiated to reduce interference. However, if the distance increases to above a threshold value (that may be the same or different as the threshold distance for initiating muting), the muting may be stopped.

In some cases, the AMS may obtain or update system information based on its state in the event-based muting paradigm. State classifications may be similar to those discussed above including a new oncoming AMS, an on-serving AMS, an on-paging AMS and an idle mode AMS. For a new oncoming AMS, the AMS may select the Macro ABS as its serving cell and, if the AMS desires a handover to the Femto ABS, the Macro ABS may reject the handover request until the Femto ABS stops muting its SFH. In some cases, the Macro ABS may negotiate with the Femto ABS to result in the Femto ABS stopping the muting of the SFH. As an alternative, the Macro ABS may give the system information of the Femto ABS to the AMS during handover preparation.

For an on-serving AMS for which event-based muting is to be employed, the on-serving AMS may receive a system information update via the messaging sequences described above in connection with FIG. 5. For an on-paging AMS for which event-based muting is to be employed, the on-paging AMS may receive a system information update via the messaging sequences described above in connection with FIG. 6. For an idle mode AMS for which event-based muting is to be employed, the idle mode AMS may perform cell selection and receive paging messages from the Macro ABS when the Femto ABS mutes its SFH.

For event-based muting of the SFH of a Femto ABS, the Femto ABS may be configured to stop muting its SFH until the Femto ABS receives the notification (e.g., from message 234 of FIG. 8) from the Macro ABS. When an AMS served by the Macro ABS sends the IM request (e.g., message 220 of FIG. 8), the IM request may also inform the Macro ABS of the Femto ABS's ID as indicated at message 222 of FIG. 8. Thereafter, the AMS may continue to monitor the received signal strength of the Femto ABS or other indications of distance of the Femto ABS to determine whether muting can be stopped based on a likelihood of low interference for the current distance. In some cases, the AMS may send a report message to the Macro ABS and then the Macro ABS may notify the Femto ABS to stop muting its SFH and return to normal operation.

In either the always-muting or the event-based muting case, the Femto ABS may be configured to allow the corresponding allocation to remain empty when the SFH is muted. This may avoid interference with the SFH of the Macro ABS, but force un-use of the corresponding resources. Alternatively, the Femto ABS may be configured to allocate data regarding allocation when the Femto ABS does not provide SFH. When transmitting, the Femto ABS may use small power or apply scheduling with location information in order to avoid interference between the data of the Femto ABS and the control channel of the Macro ABS.

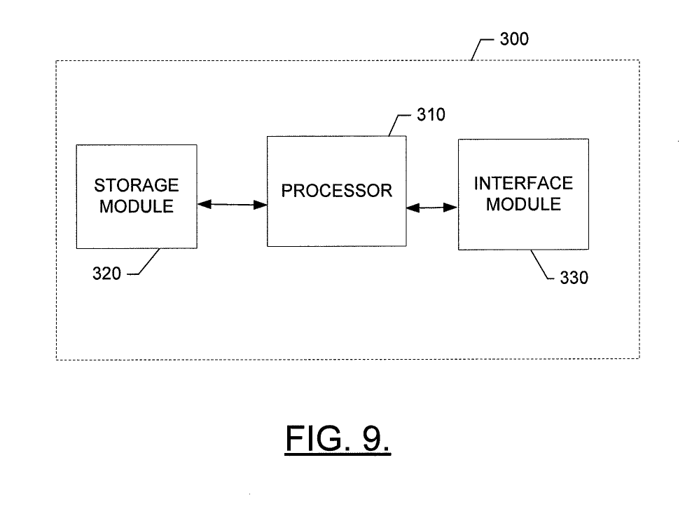

FIG. 9 illustrates an example of structure that may be employed to execute some example embodiments. In this regard, FIG. 9 illustrates an apparatus 300 that may be embodied at or as either a mobile station (e.g., an AMS) or a base station (e.g., a Femto ABS) configurable to perform example embodiments of the present invention. The apparatus 300 may include a processor 310. The processor 310 may be embodied in a number of different ways. For example, the processor 310 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 310 may be configured to execute instructions stored in a memory device or otherwise accessible to the processor 310. By executing stored instructions or operating in accordance with hard coded instructions, the processor 310 may control the operation of the apparatus 300 by directing functionality of the apparatus 300 associated with implementing event-based muting on always-muting embodiments described above from the mobile station or base station perspective according to the respective configuration provided to the apparatus 300 by the processor 310 and/or the instructions stored in memory for configuring the processor 310. As such, whether configured by hardware or software methods, or by a combination thereof, the processor 310 may represent an entity capable of performing operations according to embodiments of the present invention while configured accordingly.

The apparatus 300 may also include a storage module 320. The storage module 320 may include, for example, volatile and/or non-volatile memory. The storage module 320 may be configured to store information, instructions and/or the like. For example, the storage module 320 could be configured to buffer data for processing by the processor 310 or prior to transmission. Additionally or alternatively, the storage module 320 could be configured to store instructions for execution by the processor 310. The storage module 320 may be an integrated part of the apparatus 300 or may be a removable memory device.

In some embodiments, the apparatus 300 may further include an interface module 330. The interface module 330 may include hardware, and in some cases also software for configuring the hardware, for enabling the apparatus 300 to interface with other devices and users, if applicable. Thus, for example, if the apparatus 300 is embodied as a mobile station, the interface module 330 may include a user interface providing, for example, display, keyboard, soft keys, touch screen interface, mouse, joystick, microphone, speaker, and/or any other user interface capabilities that a mobile station may employ. The interface module 330 may also include circuitry and/or components to enable inter-device interface as well. As such, the interface module 330 may include wired and/or wireless interface circuitry such as an antenna (or antennas) and corresponding transmit and receive circuitry to enable wireless communication with other devices over a radio access technology.

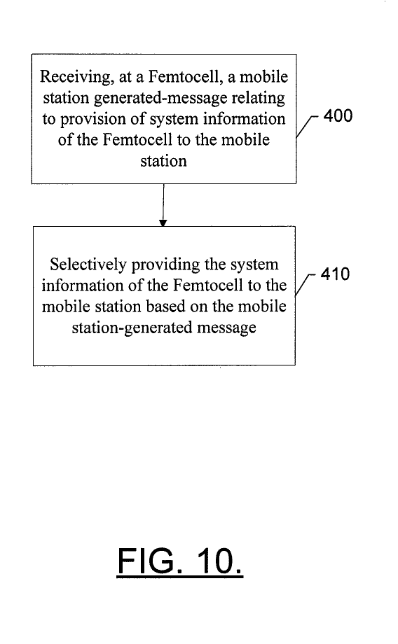

In an example embodiment, the processor 310 and/or the storage module 320 may comprise portions of processing circuitry configured to cause the apparatus 300 to perform functionality according to the configuration either hardwired into the processor 310 or provided by the execution of instructions stored in the storage module 320. As such, the apparatus 300 may be configured to control SFH muting as described above according to the perspective of the mobile station or the base station in which the apparatus 300 is employed. As such, if employed in a base station, the apparatus 300 may be configured to receive, at the base station, a mobile station generated-message relating to provision of system information of the base station to the mobile station, and selectively provide the system information of the Femtocell to the mobile station based on the mobile station-generated message. As such, the apparatus 300 may be configured to perform the method described in connection with FIG. 10 below, with or without the modifications described below.

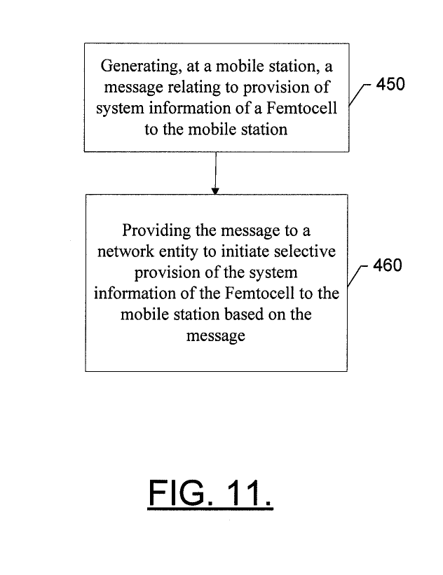

Meanwhile, when employed in a mobile station, the apparatus 300 may be configured to generate a message relating to provision of system information of a Femtocell to the mobile station, and provide the message to a network entity to initiate selective provision of the system information of the Femtocell to the mobile station based on the message. As such, the apparatus 300 may be configured to perform the method described in connection with FIG. 11 below, with or without the modifications described below.

FIGS. 10 and 11 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, in an example embodiment, the computer program instructions which embody the procedures described above are stored by a memory device and executed by a processor or controller. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). In some embodiments, the computer program instructions are stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of operations for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

One embodiment of a method for providing interference avoidance in a Femtocell network as provided in FIG. 10 may include receiving, at a Femtocell, a mobile station generated-message relating to provision of system information of the Femtocell to the mobile station at operation 400, and selectively providing the system information of the Femtocell to the mobile station based on the mobile station-generated message at operation 410.

In some embodiments, certain ones of the operations above may be modified or further amplified as described below. It should be appreciated that each of the modifications or amplifications below may be included with the operations above either alone or in combination with any others among the features described herein. In this regard, for example, selectively providing the system information may include receiving a request for the system information from the mobile station and providing non-periodic system information responsive to the request. In some cases providing non-periodic system information responsive to the request may include providing the system information to the mobile station from a cell neighboring the Femtocell. In some embodiments, providing the system information to the mobile station from the cell neighboring the Femtocell may include providing the system information from a Macrocell or different Femtocell having a coverage overlap with the Femtocell. In an example case, providing non-periodic system information responsive to the request may include providing the system information to the mobile station from the Femtocell. In some cases, providing non-periodic system information responsive to the request may include providing the system information to the mobile station for a predetermined period of time after receipt of the request. The request may be either a message or a defined code.

In some embodiments, selectively providing the system information may include periodically providing system information and stopping provision of the system information responsive to a request from the mobile station. In such an example, receiving the mobile station-generated message may include receiving the mobile station-generated message from a mobile station that is not allowed to access the Femtocell. In some cases, selectively providing the system information may include receiving the request from the mobile station based on a distance between the mobile station and the Femtocell. In an example embodiment, receiving the request from the mobile station based on a distance between the mobile station and the Femtocell may include receiving the request based on the distance being determined via signal strength measurement or via location determination. In an example embodiment, the method may further include restarting periodically providing system information responsive to expiration of a timer or responsive to receiving a notification from a neighboring cell. The request may be a message or a defined code.

In some examples, receiving the mobile station-generated message may include receiving the mobile station-generated message from a mobile station in a power saving condition, in a normal access condition, or in a powering on condition. In an example embodiment, providing non-periodic system information responsive to the request may include providing the system information to the mobile station for a predetermined period of time after receipt of the request.

Another embodiment of a method for providing interference avoidance in a Femtocell network as provided in FIG. 11 may include generating, at a mobile station, a message relating to provision of system information of a Femtocell to the mobile station at operation 450, and providing the message to a network entity to initiate selective provision of the system information of the Femtocell to the mobile station based on the message at operation 460.

In some embodiments, certain ones of the operations above may be modified or further amplified as described below. It should be appreciated that each of the modifications or amplifications below may be included with the operations above either alone or in combination with any others among the features described herein. In this regard, for example, generating the message may include generating a request for the system information. The request may be communicated to the Femtocell or to a neighbor cell of the Femtocell. In some embodiments, generating the message may include generating a request for the Femtocell to stop sending the system information. In an example embodiment, generating the request for the Femtocell to stop sending the system information may include generating the request based on a distance between the Femtocell and the mobile station.

The text and figures included herein provide examples of embodiments of the present invention, and provide support for a system, method, apparatus, and computer program product according to exemplary embodiments of the invention. It will be understood that each operation of the figures and/or text, and/or combinations of operations in the figures and/or text, can be implemented by various means. Means for implementing the operations of the figures and/or text, and/or combinations of the operations in the flowcharts and/or associated text may include hardware such as circuitry, integrated circuit devices, or the like. A hardware embodiment or means may include a hardware device that is specifically designed and configured for implementation of the operations described herein, a hardware element that is configured under the direction of program code or instructions according to the operations described herein, or a combination of both. Examples of such hardware embodiments or means may include an Application Specific Integrated Circuit (ASIC), a Programmable Logic Device (PLD), a Field Programmable Logic Array (FPGA), a processor, or other programmable apparatus. Embodiments of the present invention may also take the form of one or more of the operations described herein embodied as program code instructions stored on a computer-readable storage medium. As defined herein a “computer-readable storage medium,” which refers to a physical storage medium (e.g., volatile or non-volatile memory device), can be differentiated from a “computer-readable transmission medium,” which refers to an electromagnetic signal.

The program code instructions which embody the operations may be stored by or on a computer-readable storage medium, such as a memory device of an apparatus, and executed by one or more hardware devices. As will be appreciated, program code instructions may be loaded onto a hardware device to produce a particular and specially configured machine for implementing the operations described in the figures and/or text. Embodiments of the present invention may include hardware devices that load and execute the operations in a sequential manner, or hardware devices that load and/or execute some or all of the operations simultaneously.

It will be appreciated by one of skill in the art that the example embodiments of the present invention provided herein describe some, but not all embodiments of the invention. Indeed, the invention may be embodied in many different forms and should not be construed as limited to the embodiments set forth herein; rather, these embodiments are provided so that this disclosure will satisfy applicable legal requirements.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the present invention. Although specific terms are employed herein, they are used in a generic and descriptive sense only and not for purposes of limitation.

What is claimed is:

1. A method for providing interference avoidance in a Femtocell network, the method comprising:
receiving, at a Femtocell, a mobile station generated-message relating to provision of system information of the Femtocell to the mobile station; and
selectively providing the system information of the Femtocell to the mobile station based on the mobile station-generated message.

2. The method of claim 1, wherein selectively providing the system information comprises receiving a request for the system information from the mobile station and providing non-periodic system information responsive to the request.

3. The method of claim 2, wherein providing non-periodic system information responsive to the request comprises providing the system information to the mobile station from a cell neighboring the Femtocell.

4. The method of claim 3, wherein providing the system information to the mobile station from the cell neighboring the Femtocell comprises providing the system information from a Macrocell or different Femtocell having a coverage overlap with the Femtocell.

5. The method of claim 2, wherein providing non-periodic system information responsive to the request comprises providing the system information to the mobile station from the Femtocell.

6. The method of claim 2, wherein providing non-periodic system information responsive to the request comprises providing the system information to the mobile station for a predetermined period of time after receipt of the request.

7. The method of claim 2, wherein receiving the request comprises receiving a message or a defined code.

8. The method of claim 1, wherein selectively providing the system information comprises periodically providing system information and stopping provision of the system information responsive to a request from the mobile station.

9. The method of claim 8, wherein receiving the mobile station-generated message comprises receiving the mobile station-generated message from a mobile station that is not allowed to access the Femtocell.

10. The method of claim 8, wherein selectively providing the system information comprises receiving the request from the mobile station based on a distance between the mobile station and the Femtocell.

11. The method of claim 10, wherein receiving the request from the mobile station based on a distance between the mobile station and the Femtocell comprises receiving the request based on the distance being determined via signal strength measurement or via location determination.

12. The method of claim 8, further comprising restarting periodically providing system information responsive to expiration of a timer or responsive to receiving a notification from a neighboring cell.

13. The method of claim 8, wherein the request comprises a message or a defined code.

14. The method of claim 1, wherein receiving the mobile station-generated message comprises receiving the mobile station-generated message from a mobile station in a power saving condition, in a normal access condition, or in a powering on condition.

15. The method of claim 1, wherein providing non-periodic system information responsive to the request comprises providing the system information to the mobile station for a predetermined period of time after receipt of the request.

16. An apparatus for providing interference avoidance in a Femtocell network, the apparatus comprising processing circuitry configuring the apparatus to:
receive, at a Femtocell, a mobile station generated-message relating to provision of system information of the Femtocell to the mobile station; and
selectively provide the system information of the Femtocell to the mobile station based on the mobile station-generated message.

17. The apparatus of claim 16, wherein the processing circuitry further configures the apparatus to selectively provide the system information by receiving a request for the system information from the mobile station and providing non-periodic system information responsive to the request.

18. The apparatus of claim 16, wherein the processing circuitry further configures the apparatus to selectively provide the system information by periodically providing system information and stopping provision of the system information responsive to a request from the mobile station.

19. A method for providing interference avoidance in a Femtocell network, the method comprising:
generating, at a mobile station, a message relating to provision of system information of a Femtocell to the mobile station; and
providing the message to a network entity to initiate selective provision of the system information of the Femtocell to the mobile station based on the message.

20. The method of claim 19, wherein generating the message comprises generating a request for the system information, the request being communicated to the Femtocell or to a neighbor cell of the Femtocell.

21. The method of claim 19, wherein generating the message comprises generating a request for the Femtocell to stop sending the system information.

22. The method of claim 21, wherein generating the request for the Femtocell to stop sending the system information comprises generating the request based on a distance between the Femtocell and the mobile station.

23. A system for providing interference avoidance in a Femtocell network, the system comprising:
a Femto base station having a coverage area overlapping with at least one neighbor cell; and
a mobile station capable of receiving signaling from the Femto base station,
wherein the mobile station is configured to generate a message relating to provision of system information of the Femto base station to the mobile station, and provide the message to the Femto base station or the neighbor cell, and
wherein the Femto base station is configured to selectively provide the system information of the Femto base station to the mobile station based on the message.

24. The system of claim 23, wherein the message is generated based on a distance between the Femto base station and the mobile station.

25. The system of claim 23, wherein the mobile station is configured to generate the message by generating a request for the system information or by generating a request for the Femto base station to stop sending the system information.
